(19) United States
(12) Patent Application Publication
(10) Pub. No.: US 2016/0246121 A1
(43) Pub. Date: Aug. 25, 2016

(54) LIQUID CRYSTAL DISPLAY PANEL AND MANUFACTURING METHOD THEREOF, ARRAY SUBSTRATE

(71) Applicant: SHENZHEN CHINA STAR OPTOELECTRONICS TECHNOLOGY CO., LTD., Shenzhen City, Guangdong (CN)

(72) Inventors: Sikun HAO, Shenzhen, Guangdong (CN); Chung-Yi CHIU, Shenzhen, Guangdong (CN)

(73) Assignee: SHENZHEN CHINA STAR OPTOELECTRONICS TECHNOLOGY CO., LTD., Shenzhen City, Guangdong (CN)

(21) Appl. No.: 14/379,029

(22) PCT Filed: Jul. 31, 2014
(86) PCT No.: PCT/CN2014/083400

§ 371 Date: Aug. 15, 2014

(30) Foreign Application Priority Data
Jul. 28, 2014 (CN) 201410363522.8

(51) Int. Cl. G02F 1/1343; G02F 1/1333

(52) U.S. Cl. CPC G02F 1/134309; G02F 1/133345; G02F 1/13439

(57) ABSTRACT

A liquid crystal display (LCD) panel and a manufacturing method thereof and an array substrate are provided. A pixel unit of the LCD panel includes a liquid crystal layer interposed between first and second substrates, and a first electrode layer, a second electrode layer and an insulating layer arranged on a side of the first substrate. The first electrode layer is neighboring with the first substrate, and the insulating layer is between the first and second electrode layers. The second electrode layer is formed with an electrode pattern, and the insulating layer is formed with grooves corresponding to regions without the electrode pattern of the second electrode layer. Accordingly, a driving voltage of the LCD panel can be reduced while ensuring the display quality, the power consumption is reduced and thereby the work hour of display terminal using the LCD panel is increased.

### TECHNICAL FIELD

The present invention relates to the field of liquid crystal display, especially relates to the field of liquid crystal display based on transverse electric field mode, and particularly to a liquid crystal display panel and an array substrate thereof, and a manufacturing method of liquid crystal display panel.

### DESCRIPTION OF RELATED ART

Different from liquid crystal display panels based on longitudinal electric field modes such as twisted nematic (TN) mode and multi-domain vertical alignment (MVA) mode, a liquid crystal display panel based on transverse electric field mode such as in-plane switching (IPS) mode forms electrodes on only one substrate.

For example, as to a fringe field switching (FFS) mode liquid crystal display panel derived from the IPS mode, an electrode layer is spacedly arranged below a pixel electrode, when a driving voltage is applied, a fringe electric field is generated to make liquid crystal molecules to be deflected at the surface of the electrode layer, the transmittance of backlight is increased and a large viewing angle display is achieved. However, when the driving voltage is applied, parasitic capacitances are inevitably formed between the pixel electrode and the underlying electrode layer spaced therefrom, if the parasitic capacitances are excessively large, a charging ratio of pixel unit of the liquid crystal display panel would be influenced and thereby the display effect and quality of the liquid crystal display panel would be dramatically degraded.

Currently, the parasitic capacitances generally are reduced in the industry by increasing a thickness of an insulating layer between the pixel electrode and the underlying electrode layer. However, the increase of thickness of the insulating layer would inevitably leads to an increase of driving voltage. The increase of driving voltage would inevitably leads to an increase of power consumption of driving circuit, and thereby the work hour of a display terminal using such liquid crystal display panel would be reduced.

### SUMMARY

Accordingly, technical problems to be solved by embodiments of the present invention are to provide a liquid crystal display panel, a manufacturing method thereof and an array substrate, which can reduce the driving voltage, reduce the power consumption and increase the work hour of a display terminal using the liquid crystal display panel.

In order to solve the above technical problems, a technical solution proposed by the present invention is to provide a liquid crystal display panel having oppositely and spacedly arranged first substrate and second substrate and multiple pixel units. Each of the pixel units includes a liquid crystal layer interposed between the first substrate and the second substrate, and a first electrode layer, a second electrode layer and an insulating layer arranged on a side of the first substrate facing toward the liquid crystal layer. The first electrode layer is arranged neighboring with the first substrate. The insulating layer is interposed between the first electrode and the second electrode layer. The second electrode layer is formed with an electrode pattern. The insulating layer is formed with a groove corresponding to a region without the electrode pattern of the second electrode layer.

In an exemplary embodiment, the electrode pattern is multiple spaced strip structures, and a region of the insulating layer between neighboring two of the strip structures is formed with the groove.

In an exemplary embodiment, a depth of the groove is 0˜6000 angstroms.

In an exemplary embodiment, the first electrode layer includes a common electrode, the second electrode layer includes a pixel electrode, and the electrode pattern includes a pixel electrode pattern.

In order to solve the above technical problems, still another technical solution of the present invention is to provide a manufacturing method of a liquid crystal display panel. The manufacturing method includes: coating a photoresist layer on a base sequentially deposited with a first electrode layer, an insulating layer and a second electrode layer; performing a first etching on a region of the second electrode layer uncovered by the photoresist layer to thereby form an electrode pattern on the second electrode layer and surface expose a region of the insulating layer uncovered by the photoresist layer; performing a second etching on the surface-exposed region of the insulating layer to thereby form a groove in the insulating layer corresponding to a region without the electrode pattern of the second electrode layer; and removing the photoresist layer.

In an exemplary embodiment, the first etching is a wet-type etching, and the second etching is a dry-type etching.

In an exemplary embodiment, the formed electrode pattern is multiple spaced strip structures, and a region of the insulating layer between neighboring two of the strip structures is formed with the groove.

In an exemplary embodiment, a depth of the formed groove is 0˜6000 angstroms.

In an exemplary embodiment, the first electrode layer includes a common electrode, the second electrode layer includes a pixel electrode, and the electrode pattern includes a pixel electrode pattern.

In order to solve the above technical problems, even still another technical solution proposed by the present invention is to provide an array substrate suitable for a liquid crystal display panel having a liquid crystal layer and multiple pixel units. The array substrate includes: a base, a first electrode layer, a second electrode layer and an insulating layer arranged on a side of the base facing toward the liquid crystal layer. The first electrode layer is arranged neighboring with the base. The insulating layer is interposed between the first electrode layer and the second electrode layer. The second electrode layer is formed with an electrode pattern. The insulating layer is formed with a groove corresponding to a region without the electrode pattern of the second electrode layer.

In an exemplary embodiment, the electrode pattern is multiple spaced strip structures, and a region of the insulating layer between neighboring two of the strip structures is formed with the groove. A depth of the groove is 0˜6000 angstroms.

In an exemplary embodiment, the first electrode layer includes a common electrode, a second electrode layer includes a pixel electrode, and the electrode pattern includes a pixel electrode pattern.

By the above technical solutions, beneficial effects can be achieve by the present invention are that: by forming a groove in the insulating layer interposed between the first electrode layer and the second electrode layer, and the groove is corresponding to a region without the electrode pattern of the second electrode layer, which not only can reduce the parasitic capacitances formed by the first electrode layer and the second electrode layer being applied with a driving voltage, but also is without increasing the thickness of the insulating layer. Compared with the prior art, the driving voltage is reduced, the power is saved and the work hour of a display terminal using the liquid crystal display panel is increased.

### BRIEF DESCRIPTION OF THE DRAWINGS

FIG. 1 is a schematic structural cross-sectional view of a liquid crystal display panel according to a preferred embodiment of the present invention.

FIG. 2 is a schematic structural cross-sectional view of a pixel unit according to a preferred embodiment of the present invention.

FIG. 3 is a schematic view of transmittance of a pixel unit without groove in the prior art when a driving voltage is applied thereto.

FIG. 4 is a schematic view of transmittance of a pixel unit according to a preferred embodiment of the present invention when a driving voltage is applied thereto.

FIG. 5 is a schematic view of transmittance of a pixel unit without groove in the prior art when another driving voltage is applied thereto.

FIG. 6 is a schematic view of transmittance of a pixel unit according to a preferred embodiment of the present invention when another driving voltage is applied thereto.

FIG. 7 is a schematic view of relationships between azimuth angles and vertical locations when a same driving voltage is applied to the pixel units of FIGS. 5 and 6.

FIG. 8 is a schematic view of relationships between transmittances and driving voltages applied to pixel units with grooves of different depths according to a preferred embodiment of the present invention.

FIG. 9 is a flowchart of a manufacturing method of a liquid crystal display panel according to a preferred embodiment of the present invention.

FIG. 10 is a schematic view of a first electrode layer, an insulating layer and a second electrode layer deposited on a base in the manufacturing method of a liquid crystal display panel according to the present invention.

FIG. 11 is a schematic view of a photoresist layer coated on the second electrode layer in the manufacturing method of a liquid crystal display panel according to the present invention.

FIG. 12 is a schematic view of the photoresist layer being exposed in the manufacturing method of a liquid crystal display panel according to the present invention.

FIG. 13 is a schematic view of the second electrode layer being performed with a first etching in the manufacturing method of a liquid crystal display panel according to the present invention.

FIG. 14 is a schematic view of the insulating layer is performed with a second etching in the manufacturing method of a liquid crystal display panel according to the present invention.

FIG. 15 is a schematic view of the photoresist layer being removed in the manufacturing method of a liquid crystal display panel according to the present invention.

### DETAILED DESCRIPTION OF EMBODIMENTS

In the following, with reference to accompanying drawings of embodiments of the present invention, technical solutions in the embodiments of the present invention will be clearly and completely described. Apparently, the embodiments of the present invention described below only are a part of embodiments of the present invention, but not all embodiments. Based on the described embodiments of the present invention, all other embodiments obtained by ordinary skill in the art without creative effort belong to the scope of protection of the present invention.

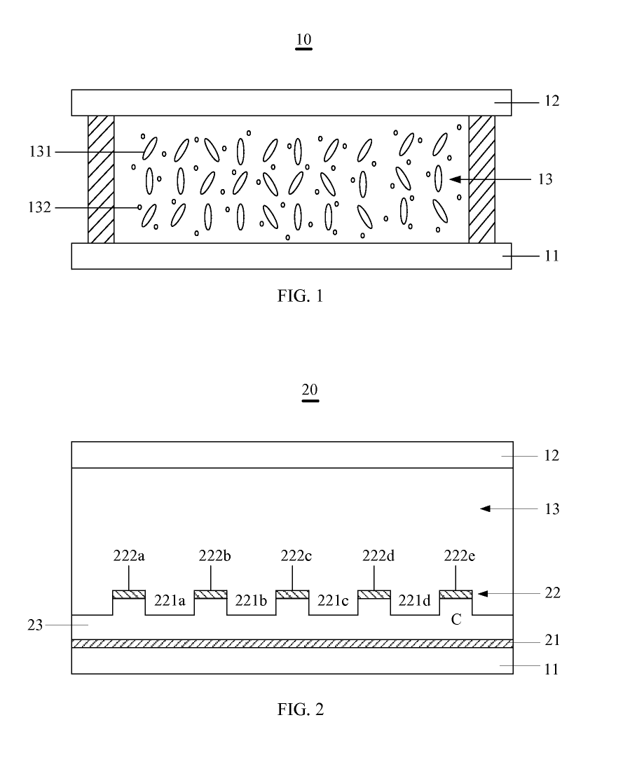

FIG. 1 is a schematic structural cross-sectional view of a liquid crystal display panel according to a preferred embodiment of the present invention. As shown FIG. 1, the liquid crystal display panel 10 in the embodiment includes a first substrate 11, a second substrate 12, a liquid crystal layer 13 and multiple pixel units (not shown).

The first substrate 11 and the second substrate 12 are oppositely and spacedly arranged. The first substrate 11 is a TFT (thin film transistor) array substrate. The first substrate 11 includes a transparent base, and various wirings, pixel electrodes and so on formed on the transparent base. The second substrate 12 is a CF (color filter) substrate.

The liquid crystal layer 13 is sandwiched between the first substrate 11 and the second substrate 12. In the embodiment, preferably, the liquid crystal layer 13 includes liquid crystal molecules 131 with negative dielectric anisotropy and multiple reactive monomers 132 mixed into the liquid crystal molecules 131. The liquid crystal molecules 131 are a liquid crystal material with characteristic of deflection and orientation in a specific direction when a driving voltage is applied, and by use of thresholds of applied driving voltage, different deflections and orientations can be achieved. The reactive monomers 132 each are a polymerizable monomer, such as acrylic resin monomer molecule, methyl acrylate resin monomer molecule, vinyl resin monomer molecule, ethylene oxide resin monomer molecule, epoxy resin monomer molecule, or any combination thereof.

FIG. 2 is a schematic structural cross-sectional view of a pixel unit according to a preferred embodiment of the present invention. Since each of pixel units of the liquid crystal display panel 10 includes R, G, B three pixels, and the pixel units have similar structures, and thus only one pixel unit 20 being taken as an example for the purpose of illustration will be described below.

Referring to FIG. 1 and FIG. 2 together, the pixel unit 20 in the embodiment includes the liquid crystal layer 13 of a corresponding region, and a first electrode layer 21, a second electrode layer 22 and an insulating layer 23 all formed on a side of the first substrate 11 facing toward the liquid crystal layer 13.

The first electrode layer 21 is arranged neighboring with the first substrate 11. The insulating layer 23 is interposed between the first electrode layer 21 and the second electrode layer 22, and thereby the first electrode layer 21 and the second electrode layer 22 are oppositely and spacedly arranged. The second electrode layer 22 is arranged neighboring with the liquid crystal layer 13.

The second electrode layer 22 in the embodiment is formed with a (pixel) electrode pattern, i.e., is a patterned electrode layer. The insulating layer 23 is formed with grooves 221a, 221b, 221c, 221d corresponding to regions without the electrode pattern of the second electrode layer 22. In particular, preferably, the electrode pattern includes multiple spaced strip structures 222a, 222b, 222c, 222d, 222e. Each of the grooves is disposed between neighboring two strip structures, i.e., as shown in FIG. 2, the groove 221a is disposed between the strip structure 222a and the strip structure 222b, the groove 221b is disposed between the strip structure 222b and the strip structure 222c, the groove 221c is disposed between the strip structure 222c and the strip structure 222d, and the groove 221d is disposed between the strip structure 222d and the strip structure 222e.

In the embodiment, the pixel unit 20 corresponds to a display region of the liquid crystal display panel 10, and correspondingly the first electrode layer 21 is a common electrode, the second electrode layer 22 is a pixel electrode and the electrode pattern formed thereon is a pixel electrode pattern. As seen from FIG.2, the first electrode layer 21 is a continuous electrode layer, and the second electrode layer 22 is a patterned electrode layer. Moreover, the first electrode layer 21 and the second electrode layer 22 both are transparent electrode layers, manufacturing materials thereof may be the same or different and may be indium tin oxide (ITO), indium zinc oxide (IZO), other transparent and electrically conductive material, or any combination thereof.

When a driving voltage is connected and applied to a side of the first substrate 11, the first electrode layer 21 and the second electrode layer 22 have parasitic capacitances C formed therebetween, i.e., the pixel electrode pattern and the first electrode layer 21 have multiple parasitic capacitances C formed therebetween. Moreover, the driving voltage makes a deflection electric field or alignment electric field for the liquid crystal layer 13 to be formed between the electrode pattern (strip structures 222a, 222b, 222c, 222d, 222e) of the second electrode layer 22 and the first electrode layer 21.

When the alignment electric field is formed, preferably, the first substrate 11 and the second substrate 12 are illuminated by a light source with ultraviolet light wave range, so that the reactive monomers 132 can be fell into place according to the electric field caused by the driving voltage and thereby achieving the alignment and deflection of the liquid crystal molecules 131 in the liquid crystal display panel 10. In particular, when the driving voltage is applied cooperative with the illumination of light in ultraviolet light wave range, the reactive monomers 132 occur polymerization to form a polymer for aligning the liquid crystal molecules 131 and thereby the liquid crystal molecules 131 are formed with a pre-tilt angle of 85˜95 degrees with respect to the first substrate 11.

When the deflection electric field is formed, since potions of the insulating layer 23 corresponding to the grooves 221a, 221b, 221c, 221d have a smaller thickness, the deflection electric field caused by the driving voltage has a large electric field intensity component on the z-axis direction in a three-dimensional coordinate system. Therefore, a torsion force for the liquid crystal molecules 131 can be significantly enhanced and the deflection angle of the liquid crystal molecules 131 is increased. That is, an azimuth angle of the pixel unit 20 is increased, a wide viewing angle thus can be achieved, the transmittance of backlight light can be improved and the aperture ratio of the liquid crystal display panel 10 can be increased. In addition, compared with the prior art, the display brightness of the pixel unit 20 is increased under the circumstance of a same driving voltage is applied. In other words, when same display brightnesses are reached, the applied driving voltage in the present embodiment as required is smaller, so that the power can be saved and the work hour of a display terminal using the liquid crystal display panel 10 can be increased.

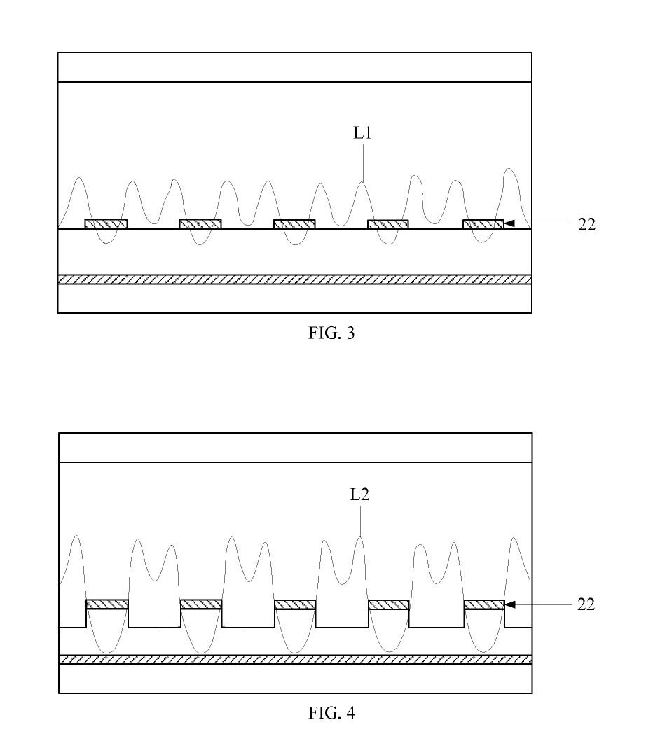

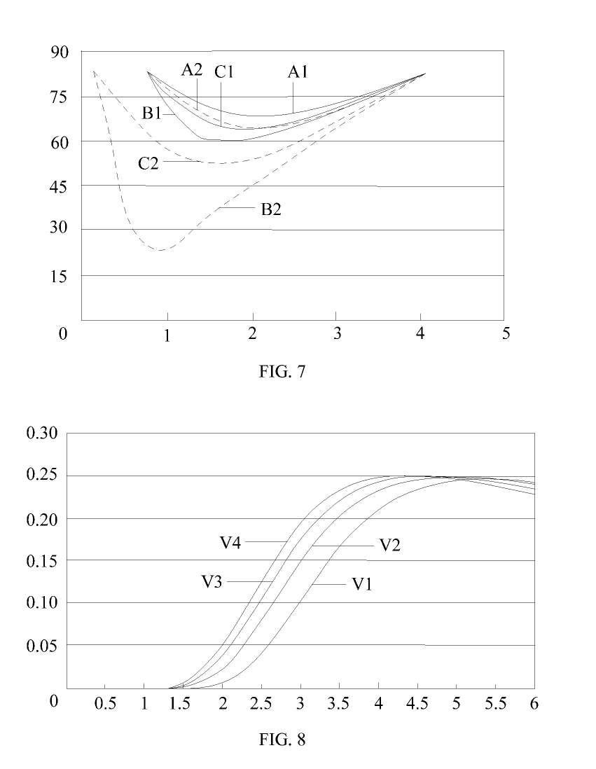

In the embodiment, preferably, a depth of each of the grooves 221a, 221b, 221c, 221d is the range of 0˜6000 angstroms (Å) but not equal to 0, i.e., greater than 0 and smaller than or equal to 6000 angstroms. In addition, the depths of the grooves 221a, 221b, 221c, 221d may be the same or different from one another. As seen from FIG. 2, the grooves 221a, 221b, 221c, 221d do not penetrate through the insulating layer 23. In the following, with reference to FIGS. 3 through 8, a situation of the grooves 221a, 221b, 221c, 221d each having a depth of 6000 angstroms and another situation of without groove (i.e., the depth of groove is 0) will be described as comparison.

Referring to FIGS. 3 and 4, when same driving voltages of 2.0 volts are applied, straight-line distances between peaks and troughs of curves L1, L2 with respect to the second electrode layer 22 represent corresponding transmittances, it is found that the transmittance L2 corresponding to the pixel unit 20 with the grooves 221a, 221b, 221c, 221d each having the depth of 6000 angstroms is larger than the transmittance L1 corresponding to a pixel unit with groove of 0 angstrom depth.

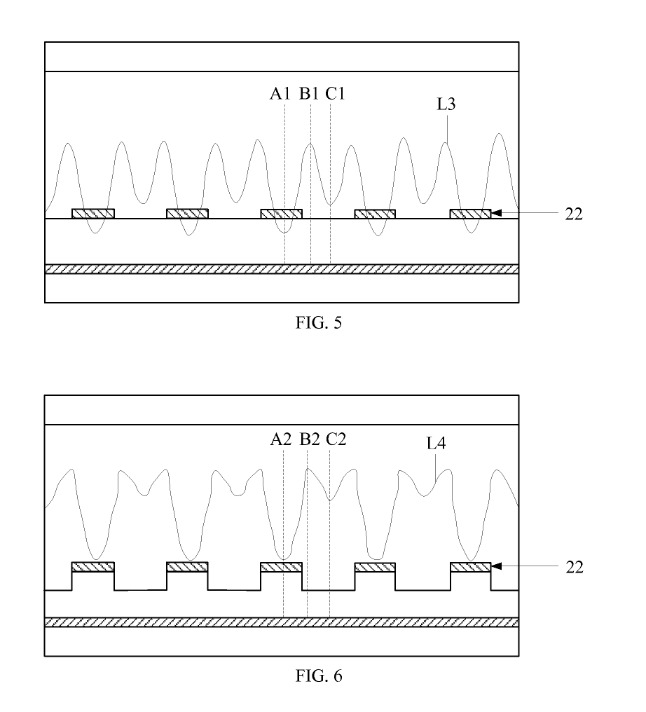

Likewise, referring to FIGS. 5 and 6, when same driving voltages of 3.0 volts are applied, straight-line distances between peaks and troughs of curves L3, L4 with respect to the second electrode layer 22 represent corresponding transmittances, it is found that the transmittance L4 corresponding to the pixel unit 20 with the grooves 221a, 221b, 221c, 221d each having the depth of 6000 angstroms is larger than the transmittance L2 corresponding to a pixel unit with groove of 0 angstrom depth.

Referring to FIGS. 4 and 6, when the depths of the grooves 221a, 221b, 221c, 221d are fixed to be 6000 angstroms, the transmittance L4 corresponding to the applied driving voltage of 3.0 volts is larger than the transmittance L2 corresponding to the applied driving voltage of 2.0 volts.

Likewise, referring to FIGS. 3 and 5, when the depth of groove is fixed to be 0, the transmittance L3 corresponding to the applied driving voltage of 3.0 volts is larger than the transmittance L1 corresponding to the applied driving voltage of 2.0 volts.

In addition, referring to FIGS. 5, 6 and 7, when the same driving voltages of 3.0 volts are applied, curves A1, B1, C1 represent relationships between vertical locations and azimuth angles corresponding to the pixel unit with groove of 0 angstrom depth, curves A2, B2, C2 represent relationships between vertical locations and azimuth angles corresponding to the pixel unit 20 with grooves each having a depth of 6000 angstroms. It is found that, when the same driving voltages are applied, compared with the pixel unit of prior art, the azimuth angle of the liquid crystal molecules 131 of the pixel unit 20 in the embodiment is increased, the increase of azimuth angle leads to the improvement of brightness of the pixel unit 20. That is, if same brightnesses are achieved, the applied driving voltage required by the pixel unit 20 in the embodiment is smaller.

Furthermore, referring to FIG. 8, the curve V1 represents a relationship between transmittance and an applied driving voltage when the depth of groove is 0, the curve V2 represents a relationship between transmittance and an applied driving voltage when the depths of the grooves 221a, 221b, 221c, 221d all are 2000 angstroms, the curve V3 represents a relationship between transmittance and an applied driving voltage when the depths of the grooves 221a, 221b, 221c, 221d all are 4000 angstroms, and the curve V4 represents a relationship between transmittance and an applied driving voltage when the depths of the grooves 221a, 221b, 221c, 221d all are 6000 angstroms. It can be found that with the increase of the depths of the grooves 221a, 221b, 221c, 221d, a starting voltage Vth and an operating voltage Vmax corresponding to a maximum brightnesses during the liquid crystal layer 13 is driven are decreased. For example, when the depths of the grooves 221a, 221b, 221c, 221d all are 0 angstrom, the staring voltage Vth is 1.8 volts and the operating voltage Vmax is 5.5 volts; when the depths of the grooves 221a, 221b, 221c, 221d are 2000 angstroms, the starting volt Vth is 1.5 volts and the operating voltage Vmax is 5 volts; when the depths of the grooves 221a, 221b, 221c, 221d are 4000 angstroms, the starting volt Vth is 1.4 volts and the operating voltage Vmax is 4.5 volts; and the depths of the grooves 221a, 221b, 221c, 221d are 6000 angstroms, the starting volt Vth is 1.3 volts and the operating voltage Vmax is 4.25 volts. That is, when the depths of the grooves 221a, 221b, 221c, 221d are increased from 0 angstrom to 6000 angstroms, the starting voltage Vth is decreased from 1.8 volts to 1.3 volts, and the operating voltage Vmax is decreased from 5.5 volts to 4.25 volts.

As seen from FIGS. 4 through 8 that, when same driving voltages are applied, the larger the depths of the grooves 221a, 221b, 221c, 221d, the higher of the transmittance corresponding to the pixel unit 20, and the higher of the display brightness of the liquid crystal display panel 10. Moreover, when the depths of the grooves 221a, 221b, 221c, 221d are fixed, the larger of the applied driving voltage, the higher of the transmittance corresponding to the pixel unit 20, and the higher of the display brightness of the liquid crystal display panel 10; that is, when same brightnesses are achieved, the applied driving voltage required by the pixel unit 20 of the present embodiment is far less than the applied driving voltage required by the pixel unit of prior art, and therefore it can reduce the power consumption compared with the prior art, the work hour of display terminal using the liquid crystal display panel 10 can be increased, the parasitic capacitances C formed by the first electrode layer 21 and the second electrode layer 22 being applied with a driving voltage can be reduced, and the thickness of the insulating layer 23 is without increase compared with the prior art.

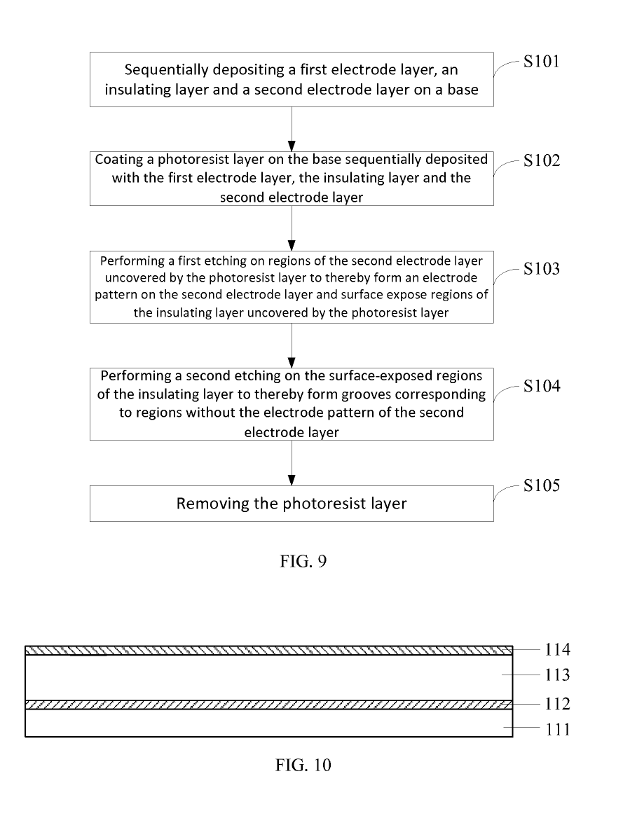

FIG. 9 is a flowchart of a manufacturing method of a liquid crystal display panel according to a preferred embodiment of the present invention. As shown in FIG. 9, the manufacturing method of a liquid crystal display panel in the embodiment includes the following steps:

Step S101: sequentially depositing a first electrode layer, an insulating layer and a second electrode layer on a base.

As shown in FIG. 10, the base 111 may be glass base, plastic base or flexible base. The first electrode layer 112 is an indium tin oxide glass layer or silicon oxide, nitride oxide or a combination thereof. The insulating layer 113 may be made of a dielectric material such as nitride oxide layer, silicon oxide layer or silicon oxynitride, and formed by chemical vapor deposition or other thin film deposition techniques. The second electrode layer 114 may have a material same as or different from that of the first electrode layer 112.

Step 102, coating a photoresist layer on the base sequentially deposited with the first electrode layer, the insulating layer and the second electrode layer.

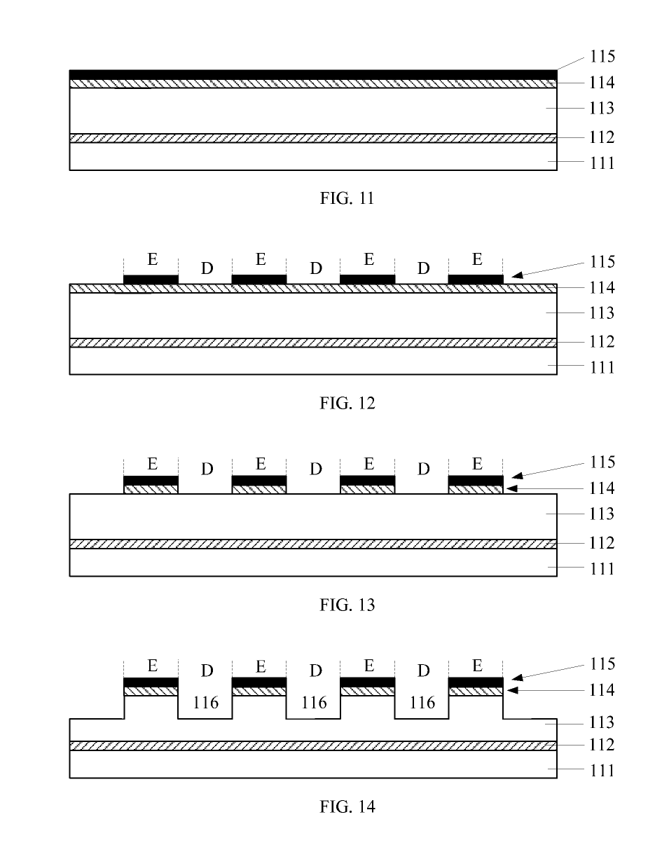

The photoresist layer 115 is coated on the second electrode layer 114. As shown in FIGS. 11 and 12, the photoresist layer 115 is performed with a first photo masking process by employing an exposure technique based on a mask (i.e., commonly known as photomask) to thereby form exposed portions D and unexposed portions E required by the photo masking process. The exposed portions D correspond to grooves will be formed, and the unexposed portions E correspond to an electrode pattern will be formed, i.e., multiple spaced strip structures.

Step 103: performing a first etching on regions of the second electrode layer uncovered by the photoresist layer to thereby form the electrode pattern on the second electrode layer and surface expose regions of the insulating layer uncovered by the photoresist layer.

As shown in FIG. 13, the photoresist layer 115 is used as an etching mask, the first etching performed on the regions of the second electrode layer 114 uncovered by the photoresist layer 115 is a wet-type etching. Since the electrode pattern will be formed includes multiple spaced strip structures, the regions of the insulating layer 113 uncovered by the photoresist 115 (corresponding to the exposed portions D) will be surface-exposed after the first etching.

Step 104, performing a second etching on the surface-exposed regions of the insulating layer to thereby form grooves in the insulating layer corresponding to regions without the electrode pattern of the second electrode layer.

As shown in FIG. 14, the photoresist layer 115 is used as an etching mask, the second etching performed on the surface-exposed regions (corresponding to the exposed portions D) of the insulating layer 112 uncovered by the photoresist layer 115 is a dry-type etching. Moreover, the regions corresponding to the exposed portions D are formed with multiple grooves 116, and the grooves 116 do not penetrate through the insulating layer 113. The grooves 116 each have a depth in the range of 0˜6000 angstroms but not equal to 0 angstrom, i.e., greater than 0 angstrom and smaller than or equal to 6000 angstroms. In addition, the depths of the grooves 116 may be the same or different from one another.

Step S105, removing the photoresist layer.

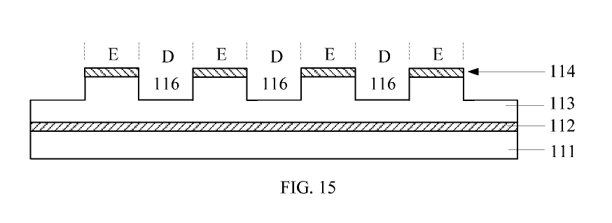

As shown in FIG. 15, a common photo masking process is used to completely expose the remaining photoresist layer 115 (corresponding to the unexposed portions E), and thereby the photoresist layer 115 is removed.

Regarding the array substrate obtained by the manufacturing method of a liquid crystal display panel of the present embodiment, a pixel unit thereof has a structure same as that of the pixel unit 20 according to the embodiment illustrated in FIG. 2, and thus can achieve the same technical effect.

In summary, in the embodiments of the present invention, the insulating layer interposed between the first electrode layer and the second electrode layer is formed with grooves, and the grooves correspond to the regions without the electrode pattern of the second electrode layer, which not only can decrease the parasitic capacitances formed by the first electrode layer and the second electrode layer being applied with a driving voltage, but also is without increasing the thickness of the insulating layer compared with the prior art. Accordingly, compared with the prior art, the driving voltage can be decreased, the power can be saved, and the work hour of a display terminal using the liquid crystal display panel can be increased consequently.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A liquid crystal display panel comprising oppositely and spacedly arranged first substrate and second substrate, and a plurality of pixel units; each of the pixel units comprising:
a liquid crystal layer interposed between the first substrate and the second substrate, and a first electrode layer, a second electrode layer and an insulating layer arranged on a side of the first substrate facing toward the liquid crystal layer; wherein the first electrode layer is arranged neighboring with the first substrate, and the insulating layer is interposed between the first electrode layer and the second electrode layer;
wherein the second electrode layer is formed with an electrode pattern, and the insulating layer is formed with a groove corresponding to a region without the electrode pattern of the second electrode layer.

2. The liquid crystal display panel as claimed in claim 1, wherein the electrode pattern is a plurality of spaced strip structures, a region of the insulating layer between neighboring two of the strip structures is formed with the groove.

3. The liquid crystal display panel as claimed in claim 2, wherein a depth of the groove is greater than 0 angstrom and smaller than or equal to 6000 angstroms.

4. The liquid crystal display panel as claimed in claim 1, wherein the first electrode layer comprises a common electrode, the second electrode layer comprises a pixel electrode, and the electrode pattern comprises a pixel electrode pattern.

5. A manufacturing method of a liquid crystal display panel, comprising:
coating a photoresist layer on a base sequentially deposited with a first electrode layer, an insulating layer and a second electrode layer;
performing a first etching on a region of the second electrode layer uncovered by the photoresist layer to thereby form an electrode pattern on the second electrode layer and surface expose a region of the insulating layer uncovered by the photoresist layer;
performing a second etching on the surface-exposed region of the insulating layer to thereby form a groove in the insulating layer corresponding to a region without the electrode pattern of the second electrode layer; and
removing the photoresist layer.

6. The manufacturing method as claimed in claim 5, wherein the first etching is a wet-type etching, and the second etching is a dry-type etching.

7. The manufacturing method as claimed in claim 5, wherein the formed electrode pattern is a plurality of spaced strip structures, and a region of the insulating layer between neighboring two of the strip structures is formed with the groove.

8. The manufacturing method as claimed in claim 7, wherein the formed groove has a depth in the range of greater than 0 angstrom and smaller than or equal to 6000 angstroms.

9. The manufacturing method as claimed in claim 5, wherein the first electrode layer comprises a common electrode, the second electrode layer comprises a pixel electrode, and the electrode pattern comprises a pixel electrode pattern.

10. An array substrate for a liquid crystal display panel having a liquid crystal layer and a plurality of pixel units, comprising:
a base, and a first electrode layer, a second electrode layer and an insulating layer formed on a side of the base facing toward the liquid crystal layer;
wherein the first electrode layer is arranged neighboring with the base, and the insulating layer is arranged interposed between the first electrode layer and the second electrode layer;
wherein the second electrode layer is formed with an electrode pattern, and the insulating layer is formed with a groove corresponding to a region without the electrode pattern of the second electrode layer.

11. The array substrate as claimed in claim 10, wherein the electrode pattern is a plurality of spaced strip structures, a region of the insulating layer between neighboring two of the strip structures is formed with the groove, and a depth of the groove is in the range of greater than 0 angstrom and smaller than or equal to 6000 angstroms.

12. The array substrate as claimed in claim 10, wherein the first electrode layer comprises a common electrode, the second electrode layer comprises a pixel electrode, and the electrode pattern comprises a pixel electrode pattern.
